(19) United States
(12) Patent Application Publication
(10) Pub. No.: US 2026/0181517 A1
(43) Pub. Date: Jun. 25, 2026

(54) CONDITIONAL HANDOVER PROCEDURE FOR CELL SUPPORTING ON-DEMAND SYSTEM INFORMATION BLOCK 1

(71) Applicant: Nokia Technologies Oy, Espoo (FI)

(72) Inventors: Sankaran BALASUBRAMANIAM, Bangalore (IN); Mads LAURIDSEN, Gistrup (DK); Daniela LASELVA, Klarup (DK); Mohamad SAYED HASSAN, Epinay sur-orge (FR)

(21) Appl. No.: 19/424,499

(22) Filed: Dec. 18, 2025

(30) Foreign Application Priority Data
Dec. 19, 2024 (IN) 202441100775

(51) Int. Cl. H04W 36/36; H04W 52/02; H04W 76/40

(52) U.S. Cl. CPC H04W 36/362; H04W 52/0235; H04W 76/40

(57) ABSTRACT

A method in a user equipment includes: receiving, by the user equipment (UE), information including: a wake-up signal (WUS) configuration for a candidate target cell prepared for conditional handover (CHO), where the candidate target cell supports on-demand system information block 1 (OD-SIB1) functionality based on a WUS; and based on the UE supporting OD-SIB1 functionality and based on conditions of the CHO being satisfied, initiating a communication towards a network apparatus serving the candidate target cell.

### CROSS-REFERENCE TO RELATED APPLICATIONS

This application claims priority to India patent application No. 202441100775, filed Dec. 19, 2024, which is hereby incorporated by reference herein in its entirety.

### FIELD

Various example embodiments relate generally to conditional handover procedure and network energy savings and, more particularly, to conditional handover procedure for cells supporting on-demand system information block 1 (OD-SIB1).

### BACKGROUND

Wireless networking provides significant advantages for user mobility. A user's ability to remain connected while on the move provides advantages not only for the user, but also provides greater efficiency and productivity for society as a whole. As expectations for connection reliability, data speed, and lower power consumption, become more demanding, technology for wireless networking must also keep pace with such expectations. Accordingly, there is continuing interest in improving wireless networking technology.

### SUMMARY

In accordance with aspects of the present disclosure, a method in a user equipment includes: receiving, by the user equipment (UE), information including: a wake-up signal (WUS) configuration for a candidate target cell prepared for conditional handover (CHO), wherein the candidate target cell supports on-demand system information block 1 (OD-SIB1) functionality based on a WUS; and based on the UE supporting OD-SIB1 functionality and based on conditions of the CHO being satisfied, initiating a communication towards a network apparatus serving the candidate target cell.

In an aspect of the method, the method may further include: determining that the UE does not have a system information block 1 (SIB1) for the candidate target cell, wherein the initiating the communication towards the network apparatus serving the candidate target cell includes: transmitting a wake-up signal, based on the WUS configuration, towards the candidate target cell, and receiving a SIB1 of the candidate target cell.

In an aspect of the method, the information may further include a system information block 1 (SIB1) of the candidate target cell.

In an aspect of the method, the method may further include: prior to the initiating the communication, determining that the SIB1 in the information is invalid.

In an aspect of the method, the SIB1 in the information may be determined to be invalid based on at least one of: expiration of a timer, or a version indicator of the SIB1, included in the information, being different from a current version indicator of a SIB1.

In an aspect of the method, the current version indicator of the SIB1 may be provided in one of: a master information block (MIB) provided by the candidate target cell, or information in a physical broadcast channel (PBCH) provided by the candidate target cell.

In an aspect of the method, the method may further include: based on determining the SIB1 in the information is invalid, transmitting a wake-up signal, based on the WUS configuration, towards the candidate target cell, and receiving a current SIB1 of the candidate target cell.

In an aspect of the method, the method may further include: starting an extended T304 timer which is longer than a default T304 timer when initiating the conditional handover, wherein the extended T304 timer provides additional time, over the default T304 timer, for the UE to transmit a WUS to the candidate target cell and for the UE to receive an OD-SIB1 from the candidate target cell.

In an aspect of the method, the extended T304 timer may be received by the UE in at least one of: the information, system information block broadcasted by the candidate target cell, or a RRC reconfiguration message.

In an aspect of the method, the initiating the communication towards the candidate target cell may include: initiating a cell switch towards the candidate target cell based on the SIB1 in the information.

In an aspect of the method, the method may further include: prior to the initiating the communication, determining that the SIB1 in the information is valid.

In an aspect of the method, the SIB1 in the information may be determined to be valid based on at least one of: non-expiration of a timer, where the timer had been started when the information comprising the SIB1 of the candidate target cell was received by the UE, or an epoch time included in the information.

In an aspect of the method, the information may be received in a RRC reconfiguration message.

In an aspect of the method, the method may further include: transmitting, to a network apparatus, an indication of the capability of the UE to support OD-SIB1.

In an aspect of the present disclosure, an apparatus includes: at least one processor; and at least one memory having stored thereon instructions which, when executed by the at least one processor, cause the apparatus to perform a method as in any one of the preceding aspects.

In an aspect of the present disclosure, a non-transitory processor-readable medium has stored thereon instructions which, when executed by at least one processor of an apparatus, cause the apparatus to perform a method as in any one of the preceding aspects.

In an aspect of the present disclosure, a method in a network apparatus includes: transmitting, to a target network apparatus serving a candidate target cell, a handover request associated with conditional handover (CHO) procedure; and receiving a response from the target network apparatus, where the response includes an indication that on-demand system information block 1 (OD-SIB1) functionality is active for the candidate target cell.

In an aspect of the method, the response may be a handover preparation failure message associated with the CHO procedure.

In an aspect of the method, the handover preparation failure message may indicate cause of failure as OD-SIB1 functionality being active.

In an aspect of the method, the response may further include a system information block 1 (SIB1) of the candidate target cell.

In an aspect of the method, the response may be one of: a handover request acknowledgment message associated with the CHO procedure, or a handover request failure message associated with the CHO procedure.

In an aspect of the method, the response may further include a wake-up signal (WUS) configuration for the candidate target cell.

In an aspect of the method, the response may be a handover request acknowledgment message associated with the CHO procedure.

In an aspect of the method, the method may further include: transmitting, to a user equipment (UE), a configuration message including at least one of: the SIB1 of the candidate target cell, or the WUS configuration for the candidate target cell.

In an aspect of the method, the configuration message may further include a timer indicating a validity period for the SIB1 of the candidate target cell.

In an aspect of the method, the configuration message may be an RRC reconfiguration message.

In an aspect of the method, the response may further include information regarding a Cell A.

In an aspect of the method, the response may be a handover request failure message.

In an aspect of the method, the method may further include: determining that the handover request has failed based on measurements of the Cell A not being available; and transmitting, to a user equipment (UE), information for the UE to acquire measurements for the Cell A.

In an aspect of the method, the response may further include information regarding a Cell A.

In an aspect of the method, the response may be a handover preparation failure message.

In an aspect of the method, the method may further include: determining that measurements of the Cell A are available; and adding the Cell A as a candidate target cell for the CHO procedure.

In an aspect of the method, the information regarding the Cell A includes at least one of: a physical cell identify for the Cell A, or a frequency allocated to the Cell A.

In an aspect of the method, the method may further include: receiving, from a user equipment (UE), an indication of capability of the UE to support OD-SIB1, wherein the handover request associated with the CHO procedure includes the indication of the capability of the UE to support OD-SIB1.

In an aspect of the method, the method may further include: receiving capability information of a user equipment (UE); in case the capability information of the UE indicates no support for OD-SIB1 functionality, determining that the CHO procedure is a failure; and in case the capability information of the UE indicates support for OD-SIB1 functionality, proceeding with the CHO procedure.

In an aspect of the present disclosure, an apparatus includes: at least one processor; and at least one memory having stored thereon instructions which, when executed by the at least one processor, cause the apparatus to perform a method as in any one of the preceding aspects.

In an aspect of the present disclosure, a non-transitory processor-readable medium has stored thereon instructions which, when executed by at least one processor of an apparatus, cause the apparatus to perform a method as in any one of the preceding aspects.

In an aspect of the present disclosure, a method in a target network apparatus serving a candidate target cell includes: receiving, by the target network apparatus serving the candidate target cell, a handover request associated with conditional handover (CHO) procedure; and transmitting a response comprising an indication that on-demand system information block 1 (OD-SIB1) functionality is active for the candidate target cell.

In an aspect of the method, the response may be a handover preparation failure message associated with the CHO procedure.

In an aspect of the method, the handover preparation failure message may indicate cause of failure as OD-SIB1 functionality being active.

In an aspect of the method, the response may further include a system information block 1 (SIB1) of the candidate target cell.

In an aspect of the method, the response may be one of: a handover request acknowledgment message associated with the CHO procedure, or a handover request failure message associated with the CHO procedure.

In an aspect of the method, the response may further include a wake-up signal (WUS) configuration for the candidate target cell.

In an aspect of the method, the response may be a handover request acknowledgment message associated with the CHO procedure.

In an aspect of the method, the response may further include information regarding a Cell A.

In an aspect of the method, the response may be a handover request failure message.

In an aspect of the method, the response may further include information regarding a Cell A.

In an aspect of the method, the response may be a handover preparation failure message.

In an aspect of the method, the information regarding the Cell A may include at least one of: a physical cell identify for the Cell A, or a frequency allocated to the Cell A.

In an aspect of the method, the handover request associated with the CHO procedure may include the indication of a capability of a user equipment (UE) to support OD-SIB1.

In an aspect of the present disclosure, an apparatus includes: at least one processor; and at least one memory having stored thereon instructions which, when executed by the at least one processor, cause the apparatus to perform a method as in any one of the preceding aspects.

In an aspect of the present disclosure, a non-transitory processor-readable medium has stored thereon instructions which, when executed by at least one processor of an apparatus, cause the apparatus to perform a method as in any one of the preceding aspects.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of example components of a network system, according to one illustrated aspect of the disclosure;

FIG. 3 is a diagram of an example of operations for conditional handover procedure involving a cell that activates on-demand system information block 1 (OD-SIB1), according to one illustrated aspect of the disclosure;

FIG. 4 is a diagram of an example of operations for conditional handover procedure involving a user equipment (UE) that does not support on-demand system information block 1 (OD-SIB1), according to one illustrated aspect of the disclosure;

FIG. 5 is a diagram of an example of operations for conditional handover procedure involving a user equipment (UE) that supports on-demand system information block 1 (OD-SIB1), according to one illustrated aspect of the disclosure; and

FIG. 6 is a diagram of an example of components of a user equipment or of a network apparatus, according to one illustrated aspect of the present disclosure.

### DETAILED DESCRIPTION

The present disclosure relates to intersection of conditional handover (CHO) procedure and network energy savings, and specifically, addresses CHO procedure for cells supporting on-demand system information block 1 (OD-SIB1).

On-demand SIB1 functionality refers to functionality for a UE to request, on-demand, a system information block 1 (SIB1) from a cell that does not broadcast SIB1. A cell that does not broadcast SIB1 may realize energy savings by transmitting SIB1 only when requested to do so by a wake-up signal (WUS). Such a cell may be referred to herein as a NES-capable cell, a NES cell, a cell operating in OD-SIB1 mode, or a cell having OD-SIB1 activated, and such terms may be used interchangeably herein. After transmitting a WUS to a NES cell, a UE may receive a SIB1 of the NES cell by monitoring a physical downlink control channel (PDCCH) for downlink control information (DCI) that schedules the SIB1 on the physical downlink shared channel (PDSCH), and by the UE receiving the PDSCH which includes the SIB1. Alternatively, the UE may receive a SIB1 of the NES cell by receiving the PDSCH which includes the SIB1, where the scheduling information for the PDSCH is preconfigured.

Networks may include NES cells, non-NES cells, UEs which are capable of OD-SIB1 functionality, and UEs which are not capable of OD-SIB1 functionality. Complications may occur in such networks. For example, UEs that do not support OD-SIB1 functionality may not be able to properly conduct handover to a target NES cell, which poses complications for conditional handover (CHO). As discussed further below, even for UEs that do support OD-SIB1 functionality, complications may arise during CHO procedure.

Conditional Handover (CHO) is a handover that is executed by the UE when one or more handover execution conditions are met, i.e. without a handover command from the network. The UE starts evaluating the execution condition(s) upon receiving the CHO configuration and stops evaluating the execution condition(s) once a handover is executed. Details of CHO procedure are available in 3rd Generation Partnership Project (3GPP) TS 38.331, section 9.2.3.4.

Aspects of the present disclosure address CHO procedure when the target cell is a cell with OD-SIB1 activated.

The following description refers to the term “Cell A.” As used herein, Cell A refers to and means a cell that periodically transmits at least its own SIB1 and is the coverage cell for a target cell such that cell A provides the WUS for the target cell.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit toward,” “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

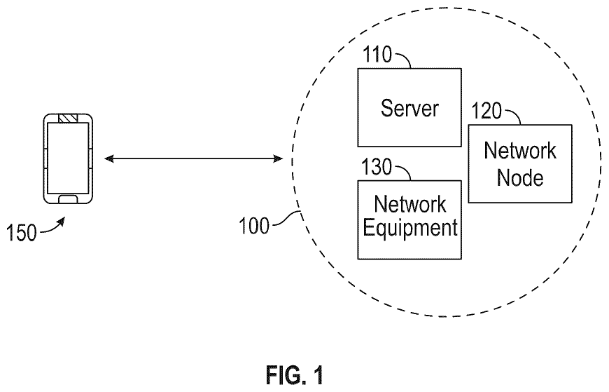

FIG. 1 is a diagram depicting an example of wireless networking between a network system 100 and a user equipment (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides new radio (NR) user plane and control plane protocol terminations towards the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)-physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QoS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021-06) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

A gNB-CU-Control Plane (gNB-CU-CP) includes, e.g., a logical node hosting, e.g., the RRC and the control plane part of the PDCP protocol of the gNB-CU for an en-gNB or a gNB. The gNB-CU-CP terminates the E1 interface connected with the gNB-CU-User Plane (gNB-CU-UP) and the F1-C interface connected with the gNB-DU.

A gNB-CU-User Plane (gNB-CU-UP) includes, e.g., a logical node hosting, e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1, which is hereby incorporated by reference herein.

As used herein, the term “network node” may refer to any of a gNB, a gNB-CU, a gNB-DU, a gNB-CU-CP, or a gNB-CU-UP, or any combination of them.

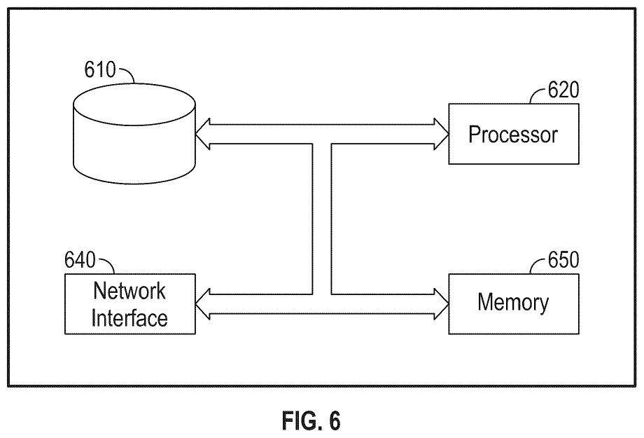

A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 6 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 6. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

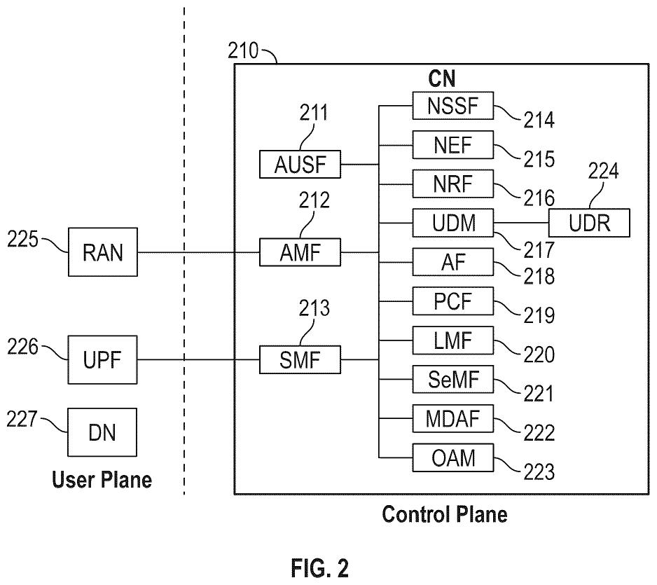

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 may include an authentication server function (AUSF) 211, an access and mobility management function (AMF) 212, and a session management function (SMF) 213. The core network 210 may also include a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 may include an application function 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QoS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

As mentioned above, in accordance with aspects of the present disclosure, the present disclosure relates to conditional handover procedure for cells supporting on-demand system information block 1 (OD-SIB1) functionality. In the description below, any reference to gNB shall be treated as though the discussion applies to a RAN node or network node, as well. Additionally, as described above, a RAN node or network node may refer to any of a gNB, a gNB-CU, a gNB-DU, a gNB-CU-CP, or a gNB-CU-UP, or any combination of them.

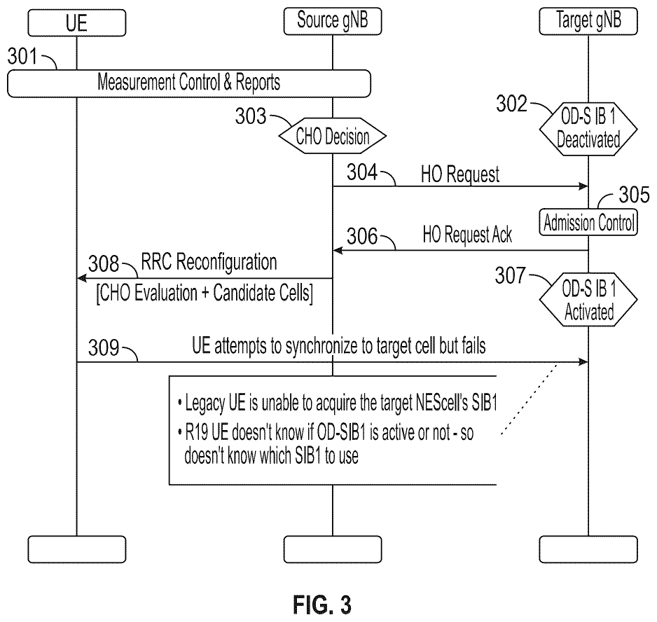

FIG. 3 shows an example of operations for conditional handover (CHO) procedure involving a cell that activates on-demand system information block 1 (OD-SIB1). The operations are performed by the components shown at the top of FIG. 3, which include a UE, a source radio access network (RAN) node (e.g., network node, gNB), and a target RAN node (e.g., gNB). Such components may be, for example, the same components described in connection with FIG. 1 and FIG. 2 or otherwise described above.

In CHO, the user equipment (UE) may report a suitable target cell to the serving cell to assist the network with candidate cells for CHO. The serving cell (of the source gNB) will then initiate a handover request towards the target cell (of a target gNB) to reserve resources for the UE. In a potential scenario, the target cell is operating in OD-SIB1 mode. According to 3rd Generation Partnership Project (3GPP) specifications TS 38.331 and TS 38.423, the target cell could include its SIB1 optionally in the Xn: HO Request Ack as part of the RRC Container which the source gNB could forward to the UE in the HO/CHO Command (i.e. RRCReconfigurationWithSync). The downlink sync operation during handover only relies on SSB for target cell, and it does not require reading system information.

In CHO, the time that UE evaluates the CHO conditions and the CHO conditions are fulfilled is not known to the network. This means that when UE detaches from its old cell and performs random access (PRACH transmission) towards the new cell, the UE is not aware of the target cell status because it is not requested to read master information block (MIB) nor system information: so UE is unaware of whether the target cell is broadcasting SIB1 (normal SIB1 mode) or providing SIB1 on-demand (OD-SIB1 mode). Per current RANI agreements on OD-SIB1, these do not enable NES cell identification by reading SSB only. Hence, the UE detecting SSB of target cell does not allow the UE to identify the NES cell status with respect to SIB1 transmission mode. This could result in the UE being unaware of SIB1 mode of the target cell and being unable to request SIB1 when communicating with the target cell as part of CHO execution, which leads to complications even for UEs that support OD-SIB1 functionality.

For a UE that does not support OD-SIB1 functionality, in this scenario, the UE receives the target cell's SIB1 in RRC reconfiguration at time TO by the source cell. However as explained above, the UE performs mobility to the target cell only when CHO conditions are satisfied at time T0+Delta. Because 3GPP specifications do not provide any requirements or expiry for CHO configuration, the value of Delta can take a large value. Then, it is not possible to guarantee that the SIB1 of target cell provided to the UE in the RRC Reconfiguration is still valid when the UE performs CHO towards the target NES cell. As the SIB1 also defines how other SIBs are scheduled (broadcast or on-demand), the SIB1 is a gateway for the UE to access all the required system information, and an invalid SIB1 will lead to complications.

The details of an example of a scenario are described below.

At operation 301, the UE transmits measurements of suitable target cells to the source RAN node to assist the network with candidate cells for CHO, and the source RAN node receives the measurements.

At operation 302, the target RAN node deactivates OD-SIB1 mode for a cell served by it, which will become a candidate target cell.

At operation 303, the source RAN node decides to prepare conditional handover (CHO) towards the candidate target cell.

At operation 304, the source RAN node transmits a handover request to the target RAN node, and the target RAN node receives the handover request from the source RAN.

At operation 305, the target RAN node performs admission control.

At operation 306, the target RAN node transmits a handover request acknowledgment to the source RAN node, and the source RAN node receives the handover request acknowledgment from the target RAN node.

At operation 307, the target RAN node activates OD-SIB1 functionality.

At operation 308, the source RAN node transmits, to the UE, an RRC reconfiguration message, including CHO evaluation and information of candidate target cells, and the UE receives the RRC reconfiguration message from the source RAN node.

At operation 309, the UE attempts to synchronize with the target cell but fails to do so. In case the UE does not support OD-SIB1 functionality, the UE is not able to acquire the target NES cell's SIB1. In case the UE support OD-SIB1 functionality, the UE does not know if OD-SIB1 is active or not and thus, it does not know which SIB1 to use.

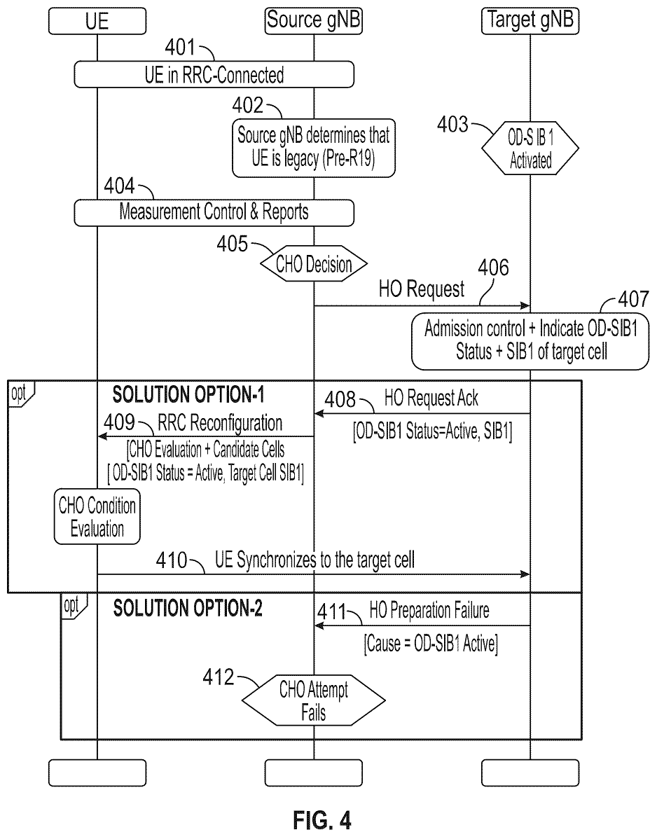

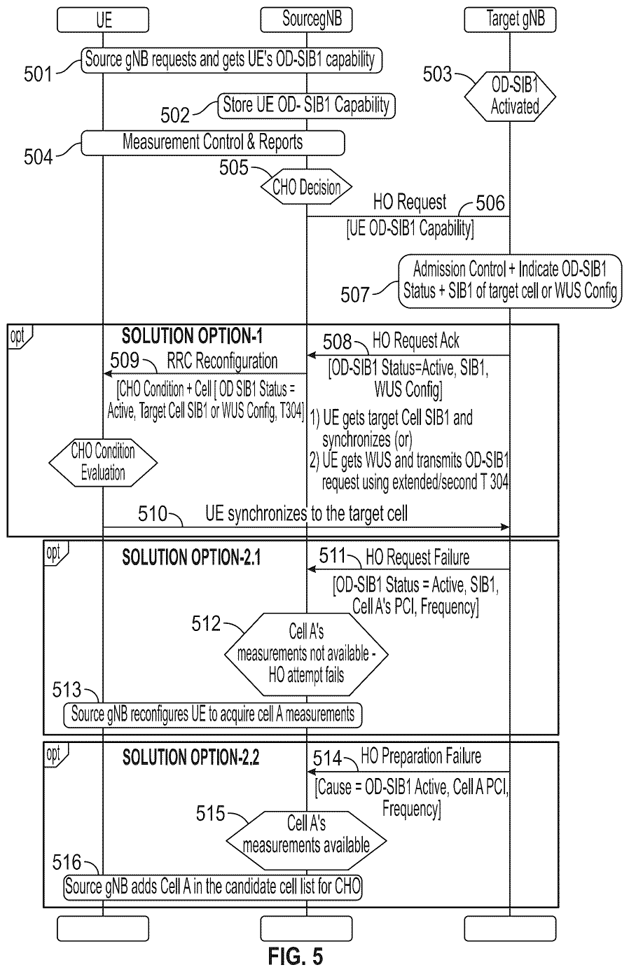

Aspects of present disclosure for addressing this scenario of FIG. 3 are described below in connection with FIG. 4 and FIG. 5.

The operations of FIG. 3 are merely examples, and variations are contemplated to be within the scope of the present disclosure. In embodiments, the operations may include others not illustrated in FIG. 3. In embodiments, the operations may not include every operation illustrated in FIG. 3. In embodiments, the operations may be implemented in a different order than that illustrated in FIG. 3. Such and other embodiments are contemplated to be within the scope of the present disclosure.

In the following description, it is assumed that the source RAN node is aware whether the UE supports OD-SIB1 mode or not (e.g., based on capabilities of the UE).

For UEs that do not support OD-SIB1 functionality, two solution options are described in connection with FIG. 4. The options described in connection with FIG. 4 also apply to UEs that do support OD-SIB1 functionality. In summary, under option 1, the target RAN node provides the SIB1 of the target cell in the Xn: handover request acknowledgment, which is forwarded to the UE by the source RAN node. The UE uses the same SIB1 when it has to synchronize to the target cell at the time of CHO execution. Under option 2, the target RAN node responds with a handover preparation failure and indicates the cause as “OD-SIB1 mode active.” In this scenario, the source RAN node will not trigger the handover of the UE and the procedure fails.

For UEs that support OD-SIB1 functionality, there are three options, which will be described below in connection with FIG. 5. In summary, the source RAN node requests a conditional handover to the target RAN node for the UE. The request includes an indication of the UE's OD-SIB1 mode capability. The source RAN node may specifically have requested this capability from the UE in previous signaling.

Under option 1, the target RAN node responds to the conditional handover request with handover request acknowledgment that includes the wake-up signal (WUS) configuration and, optionally, its current SIB1. The source RAN node provides the WUS configuration (and optionally SIB1) to the UE as part of the RRC reconfiguration message. The UE receiving the WUS configuration (and optionally SIB1) of the target NES cell can then, after the CHO is executed or triggered to be executed, attempt to communicate with the target cell by sending the WUS as a request for SIB1, if the UE determines the SIB1 received in RRC reconfiguration is not valid. The determination can be based, for example, on the timer configured from the network or a defined timer in the UE, which should be triggered from the reception of the SIB1 to the CHO execution. If the timer has not expired, the SIB1 is determined to be valid. In another example, the determination can be based on a SIB1 version, which may be referred to as a “value tag.” Alternatively, the UE may use the SIB1 information, if needed, received in the RRC reconfiguration message for CHO mobility. If the UE fails to complete the CHO towards the target NES cell (e.g., as demonstrated through the example of the random access preamble (PRACH) in SIB1 (identifying contention-based random access (CBRA) resources), and if the contention-free random access (CFRA) is not configured and are outdated), the UE can fall back to the option where it could use the WUS configuration for requesting OD-SIB1 and then perform CHO. The RRC reconfiguration message provided by the source RAN node may indicate a timer T304 is extended to allow for the OD-SIB1 procedure to complete. Alternatively, the UE utilizes a previously configured second instance of timer T304 when the handover event involves the OD-SIB1 procedure.

Under options 2.1 and 2.2, the target RAN node responds to the conditional handover request with CHO request failure (option 2.1) or a CHO preparation failure (option 2.2) and includes at least one of the Cell A physical cell identifier (PCI) or frequency allocated to the Cell A (also referred to as “frequency layer”). The source RAN node can configure the UE to measure cell A as a new target cell and optionally indicate cell A provides the WUS of the target cell.

With regard to a RRC reconfiguration message, 3GPP TS 38.331 defines how the RRC reconfiguration message can (optionally) deliver a target cell SIB1 (i.e., by information element “dedicatedSIB1-Delivery”.

With regard to the T304 timer, TS 38.331 defines the timer T304, which the UE starts when it is asked to handover (reconfiguration with sync). Information for the T304 timer is provided below. Persons skilled in the art will understand the T304 timer and the description below.

| Start | Stop | At expiry |
|---|---|---|
| Upon reception of | Upon successful | For T304 of MCG, in case |
| RRCReconfiguration | completion of random | of the handover from NR |
| message including | access on the | or intra-NR handover, or |
| reconfiguration WithSync for | corresponding SpCell. | path switch from a L2 |
| the MCG which does not | In case of a | U2N Relay UE to a NR |
| include sl-PathSwitchConfig, | reconfiguration with sync | cell, or a reconfiguration |
| or upon reception of | without performing | with sync without |
| RRCReconfiguration | random access procedure, | performing random access |
| message including | upon receiving a PDCCH | procedure, or an LTM cell |
| reconfiguration WithSync for | transmission addressed to | switch procedure, initiate |
| the SCG not indicated as | C-RNTI after first UL | the RRC re-establishment |
| deactivated in the NR or | transmission, for the same | procedure; In case of |
| E-UTRA message containing | HARQ process. | handover to NR, perform |
| the RRCReconfiguration | In case of an LTM cell | the actions defined in the |
| message or upon conditional | switch without | specifications applicable |
| reconfiguration execution i.e. | performing a random | for the source RAT. If any |
| when applying a stored | access procedure, upon | DAPS bearer is configured |
| RRCReconfiguration | receiving a PDCCH | and if there is no RLF in |
| message including | transmission addressed to | source PCell, initiate the |
| reconfiguration WithSync. | C-RNTI after first UL | failure information |
| Also, for the MCG and SCG | transmission, for the same | procedure. |
| upon an indication from | HARQ process. | For T304 of SCG, inform |
| lower layer that an LTM cell | Upon receiving an | network about the |
| switch procedure is triggered | indication from lower | reconfiguration with sync |
| and, for the MCG, upon | layers of successful | failure by initiating the |
| performing an LTM cell | completion of Rach-less | SCG failure information |
| switch procedure following | handover. | procedure as specified in |
| cell selection performed | For T304 of SCG, upon | 5.7.3. |
| while timer T311 is running. | SCG release. | |

FIG. 4 is a diagram of example of operations for conditional handover procedure involving a user equipment (UE) that does not support on-demand system information block 1 (OD-SIB1) functionality. The operations of FIG. 4 are also appliable to UEs that do support OD-SIB1 functionality. The operations are performed by the components shown at the top of FIG. 4, which include a UE, a source radio access network (RAN) node (e.g., network node, gNB), and a target RAN node (e.g., network node, gNB). Such components may be, for example, the same components described in connection with FIG. 1 and FIG. 2 or otherwise described above.

At operation 401, the UE is in RRC-Connected state with the source RAN node.

At operation 402, the source RAN node determines that the UE does not support OD-SIB1 functionality (e.g., based on capability information of the UE previously provided by the UE, etc.).

At operation 403, the target RAN node activates the OD-SIB1 mode for a cell served by it, which will become a candidate target cell.

At operation 404, the UE transmits measurements of suitable target cells to the source RAN node to assist the network with candidate cells for CHO, and the source RAN node receives the measurements. In the illustrated scenario, the measurements include measurements for the cell served by the target RAN node, which becomes a candidate target cell.

At operation 405, the source RAN node decides to prepare the candidate target cell for CHO.

At operation 406, the source RAN node transmits a handover request to the target RAN node serving the candidate target cell, and the target RAN node receives the handover request from the source RAN node.

At operation 407, the target RAN node performs admission control. The target RAN node indicates its OD-SIB1 status, which is active in the illustrated scenario. In embodiments, the target RAN node also indicates the SIB1 of the target cell. After operation 407, there are two options that can be pursued. Option 1 is indicated by operations 408-410. Option 2 is indicated by operations 411 and 412.

Under option 1, at operation 408, the target RAN node transmits a handover request acknowledgment to the source RAN node, and the source RAN node receives the handover request acknowledgment. Based on the target cell, served by the target RAN node, being in OD-SIB1 mode (i.e. OD-SIB1 is active), the target RAN indicates the SIB1 for the target cell along with the OD-SIB1 active status to the source RAN node in the handover request acknowledgment.

At operation 409, the source RAN node transmits, to the UE, an RRC reconfiguration message, including CHO evaluation conditions and information on the candidate target cell, and the UE receives the RRC reconfiguration message. The information on the candidate target cell includes the SIB1 for the candidate target cell.

The UE then evaluates the CHO conditions.

At operation 410, based on the CHO conditions being satisfied, the UE synchronizes to the target cell.

Under solution option 2, at operation 411, the target RAN node transmits, to the source RAN node, a handover preparation failure message, including the cause of the failure as OD-SIB1 being active, and the source RAN node receives the handover preparation failure message from the target RAN node.

At operation 412, the source RAN node determines that the CHO attempt has failed, based on the UE not supporting OD-SIB1 functionality and the target cell having OD-SIB1 active.

The following will describe various operation in FIG. 4 from various perspectives.

From the perspective of a source RAN node, a method in a network apparatus includes: transmitting, to a target network apparatus serving a candidate target cell, a handover request associated with conditional handover (CHO) procedure (e.g., operation 406); and receiving a response from the target network apparatus, where the response includes an indication that on-demand system information block 1 (OD-SIB1) functionality is active for the candidate target cell (e.g., operations 408 or 411).

From the perspective of a target RAN node, a method in a target network apparatus serving a candidate target cell includes: receiving, by the target network apparatus serving the candidate target cell, a handover request associated with conditional handover (CHO) procedure (e.g., operation 406); and transmitting a response comprising an indication that on-demand system information block 1 (OD-SIB1) functionality is active for the candidate target cell (e.g., operations 408 or 411).

The operations of FIG. 4 are merely examples, and variations are contemplated to be within the scope of the present disclosure. In embodiments, the operations may include others not illustrated in FIG. 4. In embodiments, the operations may not include every operation illustrated in FIG. 4. In embodiments, the operations may be implemented in a different order than that illustrated in FIG. 4. Such and other embodiments are contemplated to be within the scope of the present disclosure.

FIG. 5 is a diagram of an example of operations for conditional handover procedure involving a user equipment (UE) that supports on-demand system information block 1 (OD-SIB1) functionality. The operations are performed by the components shown at the top of FIG. 5, which include a user equipment (UE), a source radio access network (RAN) node (e.g., network apparatus, gNB), and a target RAN node (e.g., network apparatus, gNB). Such components may be, for example, the same components described in connection with FIG. 1 and FIG. 2 or otherwise described above.

At operation 501, the source RAN requests and receives capability information of the UE. In the illustrated scenario, the capability information indicates that the UE supports OD-SIB1 functionality.

At operation 502, the source RAN node stores the UE's support of OD-SIB1 functionality.

At operation 503, the target RAN node activates OD-SIB1 mode for a cell served by it, which will become a candidate target cell.

At operation 504, the UE transmits measurements of suitable target cells to the source RAN node to assist the network with candidate cells for CHO, and the source RAN node receives the measurements. In the illustrated scenario, the measurements include measurements for the cell served by the target RAN node, which becomes a candidate target cell.

At operation 505, the source RAN node decides to prepare the candidate target cell for CHO.

At operation 506, the source RAN node transmits a handover request to the target RAN node serving the candidate target cell, and the target RAN node receives the handover request from the source RAN node. The handover request includes an indication that the UE supports OD-SIB1 functionality.

At operation 507, the target RAN node performs admission control. The target RAN node indicates its OD-SIB1 status, which is active in the illustrated scenario. In embodiments, the target RAN node indicates the wake-up signal (WUS) configuration of the candidate target cell and optionally also indicates the SIB1 of the candidate target cell. After operation 407, there are three options that can be pursued. Option 1 is indicated by operations 508-510. Option 2.1 is indicated by operations 511-513. Option 2.2 is indicated by operations 514-516

Under option 1, at operation 508, the target RAN node transmits a handover request acknowledgment to the source RAN node, and the source RAN node receives the handover request acknowledgment. Based on the target cell being in OD-SIB1 mode (i.e., OD-SIB1 active status), the target RAN node indicates the WUS configuration of the candidate target cell in the handover request acknowledgment. Optionally, the target RAN node can indicate the SIB1 of the candidate target cell in the handover request acknowledgment.

At operation 509, the source RAN node transmits, to the UE, an RRC reconfiguration message, including CHO evaluation conditions and information of candidate target cells, and the UE receives the RRC reconfiguration message from the source RAN node. The information of candidate target cells includes the indication that OD-SIB1 is active for the candidate target cell. In embodiments, the information of candidate target cells includes the WUS configuration of the candidate target cell and, optionally, the SIB1 of the candidate target cell. In embodiments, the information of the candidate target cells also includes an extended T304 timer that is longer than a default T304 timer. The extended T304 timer allows additional time for the UE to transmit a wake-up signal to the target cell to receive a SIB1. In embodiments, the extended T304 timer may be a second instance of a T304 timer.

After operation 509, the UE evaluates the CHO condition(s).

At operation 510, based on the CHO condition(s) being satisfied, the UE synchronizes to the target cell using the information on the candidate target cell. This may occur in various ways, as described by the following.

In embodiments, the UE receiving the WUS configuration of the candidate target cell can, after the CHO is executed or triggered to be executed, attempt to communicate with the target cell by sending the wake-up signal (WUS) as a request for SIB1. The UE can send the WUS if it did not receive a SIB1 in RRC reconfiguration message or if the UE determines the SIB1 received in the RRC reconfiguration message is not valid. As mentioned above, the RRC reconfiguration message provided by the source RAN node may indicate an extended T304 timer to allow for the OD-SIB1 procedure to complete. Alternatively, the UE utilizes a previously configured second instance of a T304 timer.

After transmitting a WUS to the target cell, a UE may receive a SIB1 of the target cell by monitoring a physical downlink control channel (PDCCH) for downlink control information (DCI) that schedules the SIB1 on the physical downlink shared channel (PDSCH), and by the UE receiving the PDSCH which includes the SIB1.

If the UE received a SIB1 in the in RRC reconfiguration message, the UE can determine whether the SIB1 is valid.

In embodiments, the UE can determine the validity of the SIB1 based on a timer configured from the network or a defined timer in the UE, which should be triggered from the reception of the SIB1 to the CHO execution. If the timer has not expired, the SIB1 can be determined to be valid.

In embodiments, the UE can determine of validity of the SIB1 based on an epoch time included in the RRC reconfiguration message. The epoch time is an absolute point in time, such as, for example, Wednesday at 8:00 AM. If the UE receives the SIB1 at Wednesday 8:05 AM, the UE can subtract 5 minutes from the validity duration, based on the SIB1 being receive 5 minutes after the epoch time. For example, if the validity duration is 30 minutes, the UE will have a remaining validity period of 25 minutes. A UE that receives the SIB1 at Wednesday 8:10 AM will thus have a validity duration of 20 minutes. In embodiments, the epoch time can be referenced to a system frame number, and a defined duration can be used.

In embodiments, the UE can determine validity of the SIB1 can be based on a SIB1 version, which may be referred to as a “value tag.” If the RRC reconfiguration message includes SIB1, it may also indicate the version of the SIB1. The UE can determine the current version of SIB1 of the target cell by, e.g., information in the master information block (MIB) of the physical broadcast channel (PBCH) of the target cell. If the SIB1 version stored at the UE does not match the current SIB1 version of the target cell, the UE can determine the SIB1 version stored at the UE to be invalid.

In embodiments, the UE may check whether the target cell is still operating in OD-SIB1 mode or normal SIB1 broadcast mode, which can, e.g., be determined based on information in the master information block (MIB) of the physical broadcast channel (PBCH) of the target cell or information carried in the PBCH.

Under solution 2.1, at operation 511, the target RAN node transmits an handover request failure to the source RAN node, and the source RAN node receives the handover request failure. The handover request failure includes an indication that the target cell is in OD-SIB1 mode (i.e., OD-SIB1 is active) and includes the physical cell identifier (PCI) or frequency layer of Cell A. As mentioned above, Cell A refers to and means a cell that periodically transmits at least its own SIB1 and is the coverage cell for a target cell such that cell A provides the WUS for the target cell.

If the UE did not measure cell A measurements, then UE measurements for cell A are not available. In option 2.1, at operation 512, the source RAN node determines that Cell A measurements are not available, so the handover attempt has failed.

At operation 513, the source RAN node reconfigures the UE to acquire Cell A measurements so that Cell A becomes a candidate target cell. After operation 513, Cell A can be a candidate to measure for either normal handover or conditional handover.

Under option 2.2, at operation 514, the target RAN node transmits a handover preparation failure message to the source RAN node, and the source RAN node receives the handover preparation failure message from the target RAN node. The handover preparation failure message indicates the cause of the failure as OD-SIB1 being active and also includes physical cell identifier (PCI) or frequency layer of Cell A. As mentioned above, Cell A refers to and means a cell that periodically transmits at least its own SIB1 and is the coverage cell for a target cell such that cell A provides the WUS for the target cell.

If the UE did measure cell A measurements, then UE measurements for cell A are available. In option 2.2, at operation 515, the source RAN node determines that Cell A measurements are available.

At operation 516, the source RAN node adds Cell A in the candidate cell list for CHO. After operation 516, since Cell A is added to the candidate list for CHO, Cell A will be prepared for the UE to perform CHO.

The following describes various operations of FIG. 5 from various perspectives.

From the perspective of a UE, a method in a user equipment includes: receiving, by the user equipment (UE), information including: a wake-up signal (WUS) configuration for a candidate target cell prepared for conditional handover (CHO) (e.g., operation 509), wherein the candidate target cell supports on-demand system information block 1 (OD-SIB1) functionality based on a WUS; and based on the UE supporting OD-SIB1 functionality and based on conditions of the CHO being satisfied, initiating a communication towards a network apparatus serving the candidate target cell (e.g., operation 510).

From the perspective of a source RAN node, a method in a network apparatus includes: transmitting, to a target network apparatus serving a candidate target cell, a handover request associated with conditional handover (CHO) procedure (e.g., operation 506); and receiving a response from the target network apparatus, where the response includes an indication that on-demand system information block 1 (OD-SIB1) functionality is active for the candidate target cell (e.g., operations 508, 511, or 514).

From the perspective of a target RAN node, a method in a target network apparatus serving a candidate target cell includes: receiving, by the target network apparatus serving the candidate target cell, a handover request associated with conditional handover (CHO) procedure (e.g., operation 506); and transmitting a response comprising an indication that on-demand system information block 1 (OD-SIB1) functionality is active for the candidate target cell (e.g., operations 508, 511, or 514).

The operations of FIG. 5 are merely examples, and variations are contemplated to be within the scope of the present disclosure. In embodiments, the operations may include others not illustrated in FIG. 5. In embodiments, the operations may not include every operation illustrated in FIG. 5. In embodiments, the operations may be implemented in a different order than that illustrated in FIG. 5. Such and other embodiments are contemplated to be within the scope of the present disclosure.

Referring now to FIG. 6, there is shown a block diagram of example components of a UE or a network apparatus. The apparatus includes an electronic storage 610, a processor 620, a memory 650, and a network interface 640. The various components may be communicatively coupled with each other. The processor 620 may be and may include any type of processor, such as a single-core central processing unit (CPU), a multi-core CPU, a microprocessor, a digital signal processor (DSP), a System-on-Chip (SoC), or any other type of processor. The memory 650 may be a volatile type of memory, e.g., RAM, or a non-volatile type of memory, e.g., NAND flash memory. The memory 650 includes processor-readable instructions that are executable by the processor 620 to cause the apparatus to perform various operations, including those mentioned herein, such as the operations of FIGS. 3-5.

The electronic storage 610 may be and include any type of electronic storage used for storing data, such as hard disk drive, solid state drive, and/or optical disc, among other types of electronic storage. The electronic storage 610 stores processor-readable instructions for causing the apparatus to perform its operations and stores data associated with such operations, such as storing data relating to 5G NR standards, among other data. The network interface 640 may implement wireless networking technologies such as 5G NR and/or other wireless networking technologies.

The components shown in FIG. 6 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples. In the following, a “means” may be implemented by a processor and processor-readable instructions, unless the context indicates otherwise. The notation Example n.x refers to any Example having a value for n and a value for x.

Example 1.1. An apparatus in a user equipment, comprising:
means for receiving, by the user equipment (UE), information comprising:
   a wake-up signal (WUS) configuration for a candidate target cell prepared for conditional handover (CHO),
   wherein the candidate target cell supports on-demand system information block 1 (OD-SIB1) functionality based on a WUS; and
means for, based on the UE supporting OD-SIB1 functionality and based on conditions of the CHO being satisfied, initiating a communication towards a network apparatus serving the candidate target cell.

Example 1.2. The apparatus of Example 1.1, further comprising:
means for determining that the UE does not have a system information block 1 (SIB1) for the candidate target cell,
wherein the initiating the communication towards the network apparatus serving the candidate target cell comprises:
   transmitting a wake-up signal, based on the WUS configuration, towards the candidate target cell, and
   receiving a SIB1 of the candidate target cell.

Example 1.3. The apparatus of Example 1.1, wherein the information further comprise a system information block 1 (SIB1) of the candidate target cell.

Example 1.4. The apparatus of Example 1.3, further comprising:
means for, prior to the initiating the communication, determining that the SIB1 in the information is invalid.

Example 1.5. The apparatus of Example 1.4, wherein the SIB1 in the information is determined to be invalid based on at least one of:
expiration of a timer, or
a version indicator of the SIB1, included in the information, being different from a current version indicator of a SIB1.

Example 1.6. The apparatus of Example 1.5, wherein the current version indicator of the SIB1 is provided in one of: a master information block (MIB) provided by the candidate target cell, or information in a physical broadcast channel (PBCH) provided by the candidate target cell.

Example 1.7. The apparatus of any one of Example 1.4-Example 1.6, further comprising:
means for, based on determining the SIB1 in the information is invalid, transmitting a wake-up signal, based on the WUS configuration, towards the candidate target cell, and
means for receiving a current SIB1 of the candidate target cell.

Example 1.8. The apparatus of Example 1.2, further comprising:
means for starting an extended T304 timer which is longer than a default T304 timer when initiating the conditional handover,
wherein the extended T304 timer provides additional time, over the default T304 timer, for the UE to transmit a WUS to the candidate target cell and for the UE to receive an OD-SIB1 from the candidate target cell.

Example 1.9. The apparatus of Example 1.8, wherein the extended T304 timer is received by the UE in at least one of:
the information,
system information block broadcasted by the candidate target cell, or
a RRC reconfiguration message.

Example 1.10. The apparatus of Example 1.3, wherein the means for initiating the communication towards the candidate target cell comprises:
means for initiating a cell switch towards the candidate target cell based on the SIB1 in the information.

Example 1.11. The apparatus of Example 1.10, further comprising:
means for prior to the initiating the communication, determining that the SIB1 in the information is valid.

Example 1.12. The apparatus of Example 1.11, wherein the SIB1 in the information is determined to be valid based on at least one of:
non-expiration of a timer, the timer having been started when the information comprising the SIB1 of the candidate target cell was received by the UE, or
an epoch time included in the information.

Example 1.13. The apparatus of any of the preceding Examples 1.x, wherein the information is received in a RRC reconfiguration message.

Example 1.14. The apparatus of any of the preceding Examples 1.x, further comprising:
means for transmitting, to a network apparatus, an indication of the capability of the UE to support OD-SIB1.

Example 2.1. A method in a network apparatus, comprising:
transmitting, to a target network apparatus serving a candidate target cell, a handover request associated with conditional handover (CHO) procedure; and
receiving a response from the target network apparatus, the response comprising an indication that on-demand system information block 1 (OD-SIB1) functionality is active for the candidate target cell.

Example 2.2. The method of Example 2.1, wherein the response is a handover preparation failure message associated with the CHO procedure.

Example 2.3. The method of Example 2.2, wherein the handover preparation failure message indicates cause of failure as OD-SIB1 functionality being active.

Example 2.4. The method of Example 2.1, wherein the response further comprises a system information block 1 (SIB1) of the candidate target cell.

Example 2.5. The method of Example 2.4, wherein the response is one of:
a handover request acknowledgment message associated with the CHO procedure, or
a handover request failure message associated with the CHO procedure.

Example 2.6. The method of Example 2.2 or Example 2.4, wherein the response further comprises a wake-up signal (WUS) configuration for the candidate target cell.

Example 2.7. The method of Example 2.6, wherein the response is a handover request acknowledgment message associated with the CHO procedure.

Example 2.8. The method of Example 2.4 or Example 2.6, further comprising: transmitting, to a user equipment (UE), a configuration message comprising at least one of:
the SIB1 of the candidate target cell, or
the WUS configuration for the candidate target cell.

Example 2.9. The method of Example 2.8, wherein the configuration message further comprises a timer indicating a validity period for the SIB1 of the candidate target cell.

Example 2.10. The method of Example 2.8 or Example 2.9, wherein the configuration message is an RRC reconfiguration message.

Example 2.11. The method of Example 2.4, wherein the response further comprises information regarding a Cell A.

Example 2.12. The method of Example 2.11, wherein the response is a handover request failure message.

Example 2.13. The method of Example 2.11 or Example 2.12, further comprising: determining that the handover request has failed based on measurements of the Cell A not being available; and
transmitting, to a user equipment (UE), information for the UE to acquire measurements for the Cell A.

Example 2.14. The method of Example 2.1, wherein the response further comprises information regarding a Cell A.

Example 2.15. The method of Example 2.16, wherein the response is a handover preparation failure message.

Example 2.16. The method of Example 2.14 or Example 2.15, further comprising:
determining that measurements of the Cell A are available; and
adding the Cell A as a candidate target cell for the CHO procedure.

Example 2.17. The method of any one of Example 2.11-Example 2.16, wherein the information regarding the Cell A comprises at least one of:
a physical cell identify for the Cell A, or
a frequency allocated to the Cell A.

Example 2.18. The method as in any one of the preceding Examples 2.x, further comprising:
receiving, from a user equipment (UE), an indication of capability of the UE to support OD-SIB1,
wherein the handover request associated with the CHO procedure comprises the indication of the capability of the UE to support OD-SIB1.

Example 2.19. The method of Example 2.1, further comprising:
receiving capability information of a user equipment (UE);
in case the capability information of the UE indicates no support for OD-SIB1 functionality, determining that the CHO procedure is a failure; and
in case the capability information of the UE indicates support for OD-SIB1 functionality, proceeding with the CHO procedure.

Example 2.20. An apparatus comprising:
at least one processor; and
at least one memory having stored thereon instructions which, when executed by the at least one processor, cause the apparatus to perform a method as in any one of the preceding Example 2.x.

Example 2.21. A non-transitory processor-readable medium having stored thereon instructions which, when executed by at least one processor of an apparatus, cause the apparatus to perform a method as in any one of Example 2.1-Example 2.19.

Example 3.1. An apparatus in a network apparatus, comprising:
means for transmitting, to a target network apparatus serving a candidate target cell, a handover request associated with conditional handover (CHO) procedure; and
means for receiving a response from the target network apparatus, the response comprising an indication that on-demand system information block 1 (OD-SIB1) functionality is active for the candidate target cell.

Example 3.2. The apparatus of Example 3.1, wherein the response is a handover preparation failure message associated with the CHO procedure.

Example 3.3. The apparatus of Example 3.2, wherein the handover preparation failure message indicates cause of failure as OD-SIB1 functionality being active.

Example 3.4. The apparatus of Example 3.1, wherein the response further comprises a system information block 1 (SIB1) of the candidate target cell.

Example 3.5. The method of Example 3.4, wherein the response is one of:
a handover request acknowledgment message associated with the CHO procedure, or
a handover request failure message associated with the CHO procedure.

Example 3.6. The apparatus of Example 3.2 or Example 3.4, wherein the response further comprises a wake-up signal (WUS) configuration for the candidate target cell.

Example 3.7. The apparatus of Example 3.6, wherein the response is a handover request acknowledgment message associated with the CHO procedure.

Example 3.8. The apparatus of Example 3.4 or Example 3.6, further comprising:
means for transmitting, to a user equipment (UE), a configuration message comprising at least one of:
   the SIB1 of the candidate target cell, or
   the WUS configuration for the candidate target cell.

Example 3.9. The apparatus of Example 3.8, wherein the configuration message further comprises a timer indicating a validity period for the SIB1 of the candidate target cell.

Example 3.10. The apparatus of Example 3.8 or Example 3.9, wherein the configuration message is an RRC reconfiguration message.

Example 3.11. The apparatus of Example 3.4, wherein the response further comprises information regarding a Cell A.

Example 3.12. The apparatus of Example 3.11, wherein the response is a handover request failure message.

Example 3.13. The apparatus of Example 3.11 or Example 3.12, further comprising:
means for determining that the handover request has failed based on measurements of the Cell A not being available; and
means for transmitting, to a user equipment (UE), information for the UE to acquire measurements for the Cell A.

Example 3.14. The apparatus of Example 3.1, wherein the response further comprises information regarding a Cell A.

Example 3.15. The apparatus of Example 3.16, wherein the response is a handover preparation failure message.

Example 3.16. The apparatus of Example 3.14 or Example 3.15, further comprising:
means for determining that measurements of the Cell A are available; and
means for adding the Cell A as a candidate target cell for the CHO procedure.

Example 3.17. The apparatus of any one of Example 3.11-Example 3.16, wherein the information regarding the Cell A comprises at least one of:
a physical cell identify for the Cell A, or
a frequency allocated to the Cell A.

Example 3.18. The apparatus as in any one of the preceding Examples 3.x, further comprising:
means for receiving, from a user equipment (UE), an indication of capability of the UE to support OD-SIB1,
wherein the handover request associated with the CHO procedure comprises the indication of the capability of the UE to support OD-SIB1.

Example 3.19. The apparatus of Example 3.1, further comprising:
means for receiving capability information of a user equipment (UE);
means for, in case the capability information of the UE indicates no support for OD-SIB1 functionality, determining that the CHO procedure is a failure; and
means for, in case the capability information of the UE indicates support for OD-SIB1 functionality, proceeding with the CHO procedure.

Example 4.1. A method in a target network apparatus serving a candidate target cell, comprising:
receiving, by the target network apparatus serving the candidate target cell, a handover request associated with conditional handover (CHO) procedure; and
transmitting a response comprising an indication that on-demand system information block 1 (OD-SIB1) functionality is active for the candidate target cell.

Example 4.2. The method of Example 4.1, wherein the response is a handover preparation failure message associated with the CHO procedure.

Example 4.3. The method of Example 4.2, wherein the handover preparation failure message indicates cause of failure as OD-SIB1 functionality being active.

Example 4.4. The method of Example 4.1, wherein the response further comprises a system information block 1 (SIB1) of the candidate target cell.

Example 4.5. The method of Example 4.4, wherein the response is one of:
a handover request acknowledgment message associated with the CHO procedure, or
a handover request failure message associated with the CHO procedure.

Example 4.6. The method of Example 4.1 or Example 4.4, wherein the response further comprises a wake-up signal (WUS) configuration for the candidate target cell.

Example 4.7. The method of Example 4.6, wherein the response is a handover request acknowledgment message associated with the CHO procedure.

Example 4.8. The method of Example 4.4, wherein the response further comprises information regarding a Cell A.

Example 4.9. The method of Example 4.8, wherein the response is a handover request failure message.

Example 4.10. The method of Example 4.1, wherein the response further comprises information regarding a Cell A.

Example 4.11. The method of Example 4.10, wherein the response is a handover preparation failure message.

Example 4.12. The method of any one of Example 4.8-Example 4.11, wherein the information regarding the Cell A comprises at least one of:
a physical cell identify for the Cell A, or
a frequency allocated to the Cell A.

Example 4.13. The method as in any one of the preceding Examples 4.x, wherein the handover request associated with the CHO procedure comprises the indication of a capability of a user equipment (UE) to support OD-SIB1.

Example 4.14. An apparatus comprising:
at least one processor; and
at least one memory having stored thereon instructions which, when executed by the at least one processor, cause the apparatus to perform a method as in any one of the preceding Examples 4.x.

Example 4.15. A non-transitory processor-readable medium having stored thereon instructions which, when executed by at least one processor of an apparatus, cause the apparatus to perform a method as in any one of Example 4.1-Example 4.13.

Example 5.1. An apparatus in a target network apparatus serving a candidate target cell, comprising:
means for receiving, by the target network apparatus serving the candidate target cell, a handover request associated with conditional handover (CHO) procedure; and
means for transmitting a response comprising an indication that on-demand system information block 1 (OD-SIB1) functionality is active for the candidate target cell.

Example 5.2. The apparatus of Example 5.1, wherein the response is a handover preparation failure message associated with the CHO procedure.

Example 5.3. The apparatus of Example 5.2, wherein the handover preparation failure message indicates cause of failure as OD-SIB1 functionality being active.

Example 5.5. The apparatus of Example 5.1, wherein the response further comprises a system information block 1 (SIB1) of the candidate target cell.

Example 5.5. The apparatus of Example 5.4, wherein the response is one of:
a handover request acknowledgment message associated with the CHO procedure, or
a handover request failure message associated with the CHO procedure.

Example 5.6. The apparatus of Example 5.1 or Example 5.4, wherein the response further comprises a wake-up signal (WUS) configuration for the candidate target cell.

Example 5.7. The apparatus of Example 5.6, wherein the response is a handover request acknowledgment message associated with the CHO procedure.

Example 5.8. The apparatus of Example 5.4, wherein the response further comprises information regarding a Cell A.

Example 5.9. The apparatus of Example 5.8, wherein the response is a handover request failure message.

Example 5.10. The apparatus of Example 5.1, wherein the response further comprises information regarding a Cell A.

Example 5.11. The apparatus of Example 5.10, wherein the response is a handover preparation failure message.

Example 5.12. The apparatus of any one of Example 5.8-Example 5.11, wherein the information regarding the Cell A comprises at least one of:
a physical cell identify for the Cell A, or
a frequency allocated to the Cell A.

Example 5.13. The apparatus as in any one of the preceding Examples 5.x, wherein the handover request associated with the CHO procedure comprises the indication of a capability of a user equipment (UE) to support OD-SIB1.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A method in a user equipment, comprising:
receiving, by the user equipment (UE), information comprising:
a wake-up signal (WUS) configuration for a candidate target cell prepared for conditional handover (CHO),
wherein the candidate target cell supports on-demand system information block 1 (OD-SIB1) functionality based on a WUS; and
based on the UE supporting OD-SIB1 functionality and based on conditions of the CHO being satisfied, initiating a communication towards a network apparatus serving the candidate target cell.

2. The method of claim 1, further comprising:
determining that the UE does not have a system information block 1 (SIB1) for the candidate target cell,
wherein the initiating the communication towards the network apparatus serving the candidate target cell comprises:
transmitting a wake-up signal, based on the WUS configuration, towards the candidate target cell, and
receiving a SIB1 of the candidate target cell.

3. The method of claim 1, wherein the information further comprise a system information block 1 (SIB1) of the candidate target cell.

4. The method of claim 3, further comprising:
prior to the initiating the communication, determining that the SIB1 in the information is invalid.

5. The method of claim 4, wherein the SIB1 in the information is determined to be invalid based on at least one of:
expiration of a timer, or
a version indicator of the SIB1, included in the information, being different from a current version indicator of a SIB1.

6. The method of claim 5, wherein the current version indicator of the SIB1 is provided in one of: a master information block (MIB) provided by the candidate target cell, or information in a physical broadcast channel (PBCH) provided by the candidate target cell.

7. The method of claim 4, further comprising:
based on determining the SIB1 in the information is invalid, transmitting a wake-up signal, based on the WUS configuration, towards the candidate target cell, and
receiving a current SIB1 of the candidate target cell.

8. The method of claim 2, further comprising:
starting an extended T304 timer which is longer than a default T304 timer when initiating the conditional handover,
wherein the extended T304 timer provides additional time, over the default T304 timer, for the UE to transmit a WUS to the candidate target cell and for the UE to receive an OD-SIB1 from the candidate target cell.

9. The method of claim 8, wherein the extended T304 timer is received by the UE in at least one of:
the information,
system information block broadcasted by the candidate target cell, or
a RRC reconfiguration message.

10. The method of claim 3, wherein the initiating the communication towards the candidate target cell comprises:
initiating a cell switch towards the candidate target cell based on the SIB1 in the information.

11. The method of claim 10, further comprising:
prior to the initiating the communication, determining that the SIB1 in the information is valid.

12. The method of claim 11, wherein the SIB1 in the information is determined to be valid based on at least one of:
non-expiration of a timer, the timer having been started when the information comprising the SIB1 of the candidate target cell was received by the UE, or
an epoch time included in the information.

13. The method of claim 1, wherein the information is received in a RRC reconfiguration message.

14. The method of claim 1, further comprising:
transmitting, to a network apparatus, an indication of capability of the UE to support OD-SIB1.

15. An apparatus comprising:
at least one processor; and
at least one memory having stored thereon instructions which, when executed by the at least one processor, cause the apparatus at least to perform:
receiving, by the apparatus, information comprising:
a wake-up signal (WUS) configuration for a candidate target cell prepared for conditional handover (CHO),
wherein the candidate target cell supports on-demand system information block 1 (OD-SIB1) functionality based on a WUS; and
based on the apparatus supporting OD-SIB1 functionality and based on conditions of the CHO being satisfied, initiating a communication towards a network apparatus serving the candidate target cell.

16. A non-transitory processor-readable medium having stored thereon instructions which, when executed by at least one processor of an apparatus, cause the apparatus at least to perform:
receiving, by the apparatus, information comprising:
a wake-up signal (WUS) configuration for a candidate target cell prepared for conditional handover (CHO),
wherein the candidate target cell supports on-demand system information block 1 (OD-SIB1) functionality based on a WUS; and
based on the apparatus supporting OD-SIB1 functionality and based on conditions of the CHO being satisfied, initiating a communication towards a network apparatus serving the candidate target cell.
